(19) United States
(12) Patent Application Publication
(10) Pub. No.: US 2025/0184199 A1
(43) Pub. Date: Jun. 5, 2025

(54) SRS SEQUENCE GENERATING

(71) Applicant: LENOVO (BEIJING) LIMITED, Beijing (CN)

(72) Inventors: Bingchao LIU, Beijing (CN); Lingling XIAO, Beijing (CN); Chenxi ZHU, Fairfax, VA (US); Wei LING, Beijing (CN); Yi ZHANG, Beijing (CN)

(21) Appl. No.: 18/694,351

(22) PCT Filed: Sep. 29, 2021
(86) PCT No.: PCT/CN2021/121673

§ 371 Date: Mar. 21, 2024

(51) Int. Cl. H04L 27/26; H04L 5/00

(52) U.S. Cl. CPC H04L 27/2613; H04L 5/005

(57) ABSTRACT

Methods and apparatuses for SRS sequence generating are disclosed. A method comprises at a remote unit comprises receiving a configuration for an SRS resource with comb size (K_{TC}) 2 or 4 or 8 and a partial frequency sounding with P_{F} being equal to 1 or 2 or 4; and transmitting the SRS resource with a SRS sequence length no less than the number of applicable CS values.

### FIELD

The subject matter disclosed herein generally relates to wireless communications, and more particularly relates to methods and apparatuses for SRS sequence generating.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Sounding Reference Signal (SRS), Resource Block (RB), Physical Resource Block (PRB), Radio Resource Control (RRC), Resource Element (RE), cyclic shifts (CSs), Code Division Multiplexing (CDM), Frequency Division Multiplexing (FDM).

Several new features are introduced to enhance the SRS capacity in NR Release 17. For example, partial frequency sounding is introduced. In addition, Comb-8 is also introduced.

Traditionally, the frequency resources used for a SRS resource is determined by the number of PRBs (m_{SRS,B}_{_{SRS}}) configured for the SRS resource. The number of PRBs (m_{SRS,B}_{_{SRS}}) is determined by the RRC parameter C_{SRS} and B_{SRS} configured per SRS resource, as illustrated in Table 1 which is specified in 3GPP TS38.211 v16.0.0.

TABLE 1

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

One way to improve the SRS capacity is partial frequency sounding, which means that the SRS resource(s) is only transmitted on partial frequency band of the allocated frequency resources in a sounding hop. It has been agreed to support that the UE only transmits the SRS resource in m_{P} (m_{P} is the largest integer that is equal to or smaller than

$$⌊ \frac{1}{{P}_{F}} {m}_{SRS , {B}_{S R S}} ⌋ )$$

contiguous PRBs in one OFDM symbol, where m_{SRS,B}_{_{SRS}} indicates the number of PRBs for a sounding hop configured by RRC signaling, P_{F} is a number that is larger than 1 (e.g. 2, 4 or 8) so that only partial frequency band is used to transmit the SRS resource. Incidentally, if P_{F}=1, the SRS resource(s) is transmitted on all the allocated frequency resources in a sounding hop. In other words, the partial frequency sounding is disabled if P_{F}=1.

One PRB consists of 12 REs. It means that if m_{SRS,B}_{_{SRS}} is configured as 4, a total of 48 (=4*12) REs can be used for SRS transmission. The UE does not transmit the SRS in all (e.g. 48) REs. Instead, one RE out of every K_{TC} contiguous REs is selected to transmit the SRS, where K_{TC} can be configured for example to 2 or 4. In other words, only

$$\frac{12 \times {m}_{S R S , {B}_{S R S}}}{{K}_{T C}}$$

REs are used for actual SRS transmission. Incidentally, if partial frequency sounding is configured, only

$$\frac{12 \times {m}_{S RS , {B}_{SRS}}}{{K}_{T C} \times {P}_{F}}$$

REs are used for actual SRS transmission. Comb-2 refers to K_{TC} being configured to 2 while Comb-4 refers to K_{TC} being configured to 4. Comb-8 introduced in NR Release 17 means that K_{TC} is configured to 8.

For Comb-8, one issue is the maximum number of cyclic shifts (CSs) supported for Comb-8. Each cyclic shift shall generate a SRS sequence. NR Release 15 specifies that the maximum number of CSs for Comb-2 is 8, and the maximum number of CSs for Comb-4 is 12. In NR Release 16, SRS resource used for positioning with single SRS antenna port was introduced with Comb-8. The maximum number of CSs for Comb-8 for SRS resource used for positioning is 6.

Two alternatives have been identified for the maximum number of CSs for Comb-8 introduced in NR Release 17 for all SRS resource usages.

For Alternative 1, the maximum number of CSs for Comb-8 is 6. The Alternative 1 works well for SRS for positioning since only single SRS port is supported. However, it does not work for SRS resource with 4 SRS ports since the resultant SRS sequences generated by 6 CSs for different SRS ports of an SRS resource are nonorthogonal.

For Alternative 2, the maximum number of CSs for Comb-8 is 12. With the Alternative 2, the maximum number of CSs may exceed the SRS sequence length, e.g. when m_{SRS,B}_{_{SRS}}=4 is configured with Comb-8 for a SRS resource, the length of the SRS resource is 6 which is less than 12. So, some of the resultant 12 SRS sequences corresponding to different CSs are nonorthogonal. Accordingly, when the SRS sequence length is shorter than the maximum number of CSs, additional rule is required to ensure that the resultant SRS sequences corresponding to the allowed CS values for a SRS resource are orthogonal.

This disclosure targets the above issues.

### BRIEF SUMMARY

Methods and apparatuses for SRS sequence generating are disclosed.

In one embodiment, a method at a remote unit (e.g. UE) comprises receiving a configuration for an SRS resource with comb size (K_{TC}) 2 or 4 or 8 and a partial frequency sounding with P_{F} being equal to 1 or 2 or 4; and transmitting the SRS resource with a SRS sequence length no less than the maximum number of applicable CS values.

In one embodiment, when K_{TC}=2, the P_{F} and SRS bandwidth (m_{SRS,B}_{_{SRS}}) are determined so that the SRS sequence length

$$\frac{\frac{12}{{P}_{F}} {m}_{SRS , {B}_{S R S}}}{{K}_{T C}}$$

is no less than 8, when K_{TC}=4, the P_{F} and the SRS bandwidth (m_{SRS,B}_{_{SRS}}) are determined so that the SRS sequence length

$$\frac{\frac{12}{{P}_{F}} {m}_{SRS , {B}_{S R S}}}{{K}_{TC}}$$

is no less than 12, and when K_{TC}=8, the P_{F} and the SRS bandwidth (m_{SRS,B}_{_{SRS}}) are determined so that the SRS sequence length

$$\frac{\frac{12}{{P}_{F}} {m}_{SRS , {B}_{S R S}}}{{K}_{T C}}$$

is no less than 12.

In another embodiment, when the SRS sequence length is 6, only partial cyclic shifts are the applicable CS values so that the SRS sequence length is no less than the number of applicable CS values. Preferably, the applicable CS values are 0, 2, 4 and 6, or 1, 3, 5 and 7 for K_{TC}=2, and the applicable CS values are 0, 2, 4, 6, 8 and 10, or 1, 3, 5, 7, 9 and 11 for K_{TC}=4 or 8.

In one embodiment, a method at a base unit comprises transmitting a configuration for an SRS resource with comb size (K_{TC}) 2 or 4 or 8 and a partial frequency sounding with P_{F} being equal to 1 or 2 or 4; and receiving the SRS resource with a SRS sequence length no less than the maximum number of applicable CS values.

In another embodiment, a remote unit (e.g. UE) comprises a receiver that receives a configuration for an SRS resource with comb size (K_{TC}) 2 or 4 or 8 and a partial frequency sounding with P_{F} being equal to 1 or 2 or 4; and a transmitter that transmits the SRS resource with a SRS sequence length no less than the maximum number of applicable CS values.

In yet another embodiment, a base unit comprises a transmitter that transmits a configuration for an SRS resource with comb size (K_{TC}) 2 or 4 or 8 and a partial frequency sounding with P_{F} being equal to 1 or 2 or 4; and a receiver that receives the SRS resource with a SRS sequence length no less than the maximum number of applicable CS values.

In another embodiment, a method at a remote unit (e.g. UE) comprises receiving a configuration for an SRS resource with 4 SRS ports (Nₐₚ^{SRS}=4); and when the maximum number of applicable cyclic shifts is 6, if the cyclic shift is configured as 0 or 1 or 2, transmitting SRS by SRS ports 1000 and 1002 by using different REs from the REs used by SRS ports 1001 and 1003.

In some embodiment, the cyclic shifts for different SRS ports in the SRS resource is obtained according to

$${n}_{S R S}^{CS , i} = ⌊ {n}_{S R S}^{CS} + \frac{{n}_{S R S}^{CS , max} ( {p}_{i} - 1000 )}{{N}_{a p}^{S R S}} ⌋ mod {n}_{S R S}^{CS , max} or {n}_{S R S}^{CS , i} = ⌊ ( {n}_{S R S}^{CS} + \frac{{n}_{SRS}^{CS , max} ( {p}_{i} - 1000 )}{{N}_{a p}^{S R S}} ) mod {n}_{SRS}^{CS , max} ⌋ ,$$

where n_{SRS}^{CS,max} is the maximum number of applicable cyclic shifts, n_{SRS}^{CS}∈{0, 1, . . . , n_{SRS}^{CS,max}−1}, i=0, 1, 2 and 3, pᵢ=1000, 1001, 1002 and 1003, and Nₐₚ^{SRS}=4.

In some other embodiment, the frequency-domain starting position for SRS ports 1000 and 1002 is determined by k̅_{TC}, and the frequency-domain starting position for SRS ports 1001 and 1003 is determined by (k̅_{TC}+K_{TC}/2) mod K_{TC}, where k̅_{TC} is the transmission comb offset for the SRS resource.

In one embodiment, a method at a base unit comprises transmitting a configuration for an SRS resource with 4 SRS ports (Nₐₚ^{SRS}=4); and when the maximum number of applicable cyclic shifts is 6, if the cyclic shift is configured as 0 or 1 or 2, receiving SRS by SRS ports 1000 and 1002 by using different REs from the REs used by SRS ports 1001 and 1003

In another embodiment, a remote unit (e.g. UE) comprises a receiver that receives a configuration for an SRS resource with 4 SRS ports (Nₐₚ^{SRS}=4); and a transmitter that, when the maximum number of applicable cyclic shifts is 6, if the cyclic shift is configured as 0 or 1 or 2, transmits SRS by SRS ports 1000 and 1002 by using different REs from the REs used by SRS ports 1001 and 1003.

In yet another embodiment, a base unit comprises a transmitter that transmits a configuration for an SRS resource with 4 SRS ports (Nₐₚ^{SRS}=4); and a receiver that, when the maximum number of applicable cyclic shifts is 6, if the cyclic shift is configured as 0 or 1 or 2, receives SRS by SRS ports 1000 and 1002 by using different REs from the REs used by SRS ports 1001 and 1003.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of a method;

FIG. 3 is a schematic block diagram illustrating apparatuses according to one embodiment;

FIG. 4 is a schematic flow chart diagram illustrating an embodiment of a method; and

FIG. 5 is a schematic flow chart diagram illustrating a further embodiment of a method.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

When Comb-8 is configured (i.e. K_{TC}=⁸), if the maximum number of cyclic shifts (CSs) (e.g. the maximum number of applicable cyclic shifts) is configured as 6, the resultant 4 SRS sequences for an SRS resource with 4 SRS ports are calculated according to the following equation:

$${r}^{( {p}_{i} )} ( n , {l}^{′} ) = {r}_{u , v}^{( {α}_{i} , δ )} ( n ) , where 0 \leq n \leq {M}_{sc , b}^{S R S} - 1 , and {l}^{′} ∈ \{ 0 , 1 , … , {N}_{symb}^{S R S} - 1 \} .$$

M_{sc,b}^{SRS} is the SRS sequence length, r_{u,v}^{(α,δ)}(n)=e^{jαn}r̅_{u,v}(n) with δ=log₂(K_{TC})=3, and the transmission comb number K_{TC}∈{2,4,8} is contained in the higher-layer parameter transmissionComb (e.g. K_{TC}=8 for Comb-8). r̅_{u,v}(n) is a Zadoff-Chu sequence (ZC sequence) if the sequence length is 36 or larger and is a pre-defined sequence if the sequence length is less than 36.

The cyclic shift αᵢ for antenna port pᵢ is given as:

$${α}_{i} = 2 π \frac{{n}_{S R S}^{CS , i}}{{n}_{S R S}^{CS , max}} , where {n}_{S R S}^{CS , i} = ( {n}_{S R S}^{CS} + \frac{{n}_{SRS}^{CS , max} ( {p}_{i} - 1000 )}{{N}_{a p}^{S R S}} ) mod {n}_{S R S}^{CS , max} ,$$

where n_{SRS}^{CS}∈{0, 1, . . . , n_{SRS}^{CS,max}−1}, n_{SRS}^{CS,max} is the maximum number of cyclic shifts, Nₐₚ^{SRS}∈{1,2,4} antenna ports (e.g. SRS ports) {p}ᵢ₌₀^{N}^{ₐₚ}^{^{SRS}}⁻¹ and pᵢ=1000+i.

When n_{SRS}^{CS,max}=6 and Nₐₚ^{CS}=4, n_{SRS}^{CS,i} will be anon-integer e.g., n_{SRS}^{CS,i}=0.5, 1.5, 2.5, 3.5, 4.5, 5.5, which shall result 4 nonorthogonal sequences r^{(p}^{ᵢ}⁾, pᵢ=1000, 1001, 1002, 1003.

The above equation

$${n}_{S R S}^{CS , i} = ( {n}_{S R S}^{CS} + \frac{{n}_{SRS}^{CS , max} ( {p}_{i} - 1000 )}{{N}_{a p}^{S R S}} ) mod {n}_{S R S}^{CS , max}$$

results a non-integer. According to a first embodiment, the above equation is enhanced to

$${n}_{S R S}^{CS , i} = ⌊ {n}_{S R S}^{CS} + \frac{{n}_{S R S}^{CS , max} ( {p}_{i} - 1000 )}{{N}_{a p}^{S R S}} ⌋ mod {n}_{S R S}^{CS , max} or {n}_{S R S}^{CS , i} = ⌊ ( {n}_{S R S}^{CS} + \frac{{n}_{SRS}^{CS , max} ( {p}_{i} - 1000 )}{{N}_{a p}^{S R S}} ) mod {n}_{SRS}^{CS , max} ⌋ ,$$

where └N┘ means the largest integer that is smaller than or equal to N.

With the enhanced equation, the resultant CS values for different antenna ports are provided in Table 2 where n_{SRS}^{CS,max}=6 and Nₐₚ^{SRS}=4. n_{SRS}^{CS,0}, n_{SRS}^{CS,1}, n_{SRS}^{CS,2} and n_{SRS}^{CS,3} indicate the parameters to derivate the exact cyclic shift α₀, α₁, α₂ and α₃ for antenna ports (e.g. SRS ports) 1000, 1001, 1002 and 1003 respectively.

TABLE 2

| | n_{SRS}^{CS, 0} | n_{SRS}^{CS, 1} | n_{SRS}^{CS, 2} | n_{SRS}^{CS, 3} |
|---|---|---|---|---|
| n_{SRS}^{CS} = 0 | 0 | 1 | 3 | 4 |
| n_{SRS}^{CS} = 1 | 1 | 2 | 4 | 5 |
| n_{SRS}^{CS} = 2 | 2 | 3 | 5 | 0 |
| n_{SRS}^{CS} = 3 | 3 | 4 | 0 | 1 |
| n_{SRS}^{CS} = 4 | 4 | 5 | 1 | 2 |
| n_{SRS}^{CS} = 5 | 5 | 0 | 2 | 3 |

According to NR Release 15 procedure, when n_{SRS}^{CS,max}=6 is configured, for n_{SRS}^{CS}=0 or 1 or 2, different SRS ports are multiplexed with CDM manner, i.e., different SRS ports are assigned with different SRS sequences in a same RE set. While for n_{SRS}^{CS}=3 or 4 or 5, SRS port 1000 and 1002 are multiplexed in a same RE set with different SRS sequences and SRS port 1001 and 1003 are multiplexed in another RE sets with different SRS sequences.

Accordingly, the SRS sequences for different SRS ports with n_{SRS}^{CS}=0 or 1 or 2 can only work for the scenario with the small delay spread. It is caused by the fact that, take n_{SRS}^{CS}=0 as an example, n_{SRS}^{CS,0}=0 and n_{SRS}^{CS,1}=1 are too close; and n_{SRS}^{CS,2}=3 and n_{SRS}^{CS,3}=4 are also too close. If the channel delay spread is larger than 1, the channel estimation performance shall deteriorate due to the interference between SRS port 1000 and SRS port 1001, and the interference between SRS port 1002 and SRS port 1003. According to the first embodiment, FDM manner is adopted for different SRS ports for n_{SRS}^{CS}=0 or 1 or 2 when n_{SRS}^{CS,max}=6 is configured. For example, SRS port 1000 and 1002 are multiplexed in a same RE set with different SRS sequences and SRS port 1001 and 1003 are multiplexed in another RE set with different SRS sequences. It means that the REs occupied by SRS ports 1000 and 1002 are different from the REs occupied by SRS ports 1001 and 1003.

In particular, the frequency-domain starting position k₀^{(p}^{ᵢ}⁾ is defined by k₀^{(p}^{ᵢ}⁾=k̅₀^{(p}^{ᵢ}⁾+Σ_{b=0}^{B}^{_{SRS}}K_{TC}M_{sc,b}^{SRS}n_{b}, where k̅₀^{(p}^{ᵢ}⁾=n_{shift}N_{sc}^{RB}+(k_{TC}^{(p}^{ᵢ}⁾+k_{offset}^{l′}) mod K_{TC}. B_{SRS} is configured by RRC signaling to determine the sounding band. The frequency domain shift value n_{shift} adjusts the SRS allocation with respect to the reference point grid and is configured by RRC signaling. n_{b} is a frequency position index.

If n_{SRS}^{CS,max}=6 and K_{TC}=8 and Nₐₚ^{SRS}=4,

$${k}_{TC}^{( {p}_{i} )} = \{ \begin{matrix}( {\overline{k}}_{T C} + {K}_{T C} / 2 ) mod {K}_{T C} & {p}_{j} ∈ \{ 1001 , 1003 \} \\ {\overline{k}}_{T C} & {p}_{i} ∈ \{ 1000 , 1002 \}\end{matrix} ,$$

otherwise (i.e. if n_{SRS}^{CS,max}=6 and K_{TC}=8 and Nₐₚ^{SRS}≠4, or n_{SRS}^{CS,max}≠6 or

$${K}_{T C} \neq 8 ) , {k}_{T C}^{( {p}_{i} )} = \{ \begin{matrix}( {\overline{k}}_{T C} + {K}_{T C} / 2 ) mod {K}_{T C} & if {n}_{SRS}^{cs} ∈ \{ {n}_{SRS}^{cs , max} / 2 , … , {n}_{SRS}^{cs , max} - 1 \} and {N}_{ap}^{SRS} = 4 and {p}_{i} ∈ \{ 1001 , 1003 \} \\ {\overline{k}}_{T C} & otherwise ( if {n}_{SRS}^{cs} ∈ \{ {n}_{SRS}^{cs , max} / 2 , … , {n}_{SRS}^{cs , max} - 1 \} and {N}_{ap}^{SRS} = 4 and {p}_{i} ∈ \{ 1000 , 1002 \} , or if {N}_{ap}^{SRS} \neq 4 )\end{matrix}$$

A second embodiment relates to determining CS values if the SRS sequence length is less than the maximum number of cyclic shifts (CSs).

In NR Release 15, as shown in Table 1, the minimal sounding band is 4 PRB (n_{SRS,B}_{_{SRS}}=4), which is equal to 48 (=4*12) REs. If Comb-8 (K_{TC}=8) is configured for a SRS resource, the SRS sequence length is 48/8=6 (without partial frequency sounding). If the supported maximum number of CSs is configured as 12 (n_{SRS}^{CS,max}=12), the resultant 12 SRS sequences each with a length of 6 corresponding to different CSs are nonorthogonal. The same situation applies for NR Release 15 comb size (Comb-2 or Comb-4, i.e. K_{TC}=² or 4) with partial frequency sounding. For example, when the sounding band is 4 PRBs with K_{TC}=2 and P_{F}=4, the resultant SRS sequence length is 6 which is less than the supported n_{SRS}^{CS,max}=8 for K_{TC}=². For another example, when the sounding band is 4 PRBs with K_{TC}=4 and P_{F}=2, the resultant SRS sequence length is 6 which is less than the supported n_{SRS}^{CS,max}=12 for K_{TC}=4.

According to a first sub-embodiment of the second embodiment, the minimal SRS sequence length for a given n_{SRS}^{CS,max} is configured to be equal to or larger than n_{SRS}^{CS,max} (the maximum number of applicable CS values). For example, as illustrated in Table 3,

$$min \{ \frac{\frac{12}{{P}_{F}} {m}_{S RS , {B}_{SRS}}}{{K}_{TC}} \}$$

is configured to be equal to or larger than n_{SRS}^{CS,max} for any K_{TC}. This can be achieved by configuring a combination of P_{F}, m_{SRS,B}_{_{SRS}} and K_{TC}. In other words, for a given K_{TC}, the P_{F} and SRS bandwidth (m_{SRS,b}_{_{SRS}}) are determined so that

$$min \{ \frac{\frac{12}{{P}_{F}} {m}_{S RS , {B}_{SRS}}}{{K}_{TC}} \}$$

is equal to or larger than n_{SRS}^{CS,max} for the given K_{TC}.

TABLE 3

| K_{TC} | n_{SRS}^{CS,max} | $min \{ \frac{\frac{12}{{P}_{F}} {m}_{SRS , {B}_{SRS}}}{{K}_{TC}} \}$ |
|---|---|---|
| 2 | 8 | 8 |
| 4 | 12 | 12 |
| 8 | 6 (only for SRS | 6 |
| | resources used to | |
| | positioning | |
| 8 | 12 | 12 |

According to a second sub-embodiment of the second embodiment, only partial CS values (with the number less than n_{SRS}^{CS,max}) can be adopted (i.e. are applicable) when the SRS sequence length is less than n_{SRS}^{CS,max}. For example, only the odd n_{SRS}^{CS} values or only the even n_{SRS}^{CS} values can be adopted.

For a first example, for SRS resource configured with K_{TC}=8 where n_{SRS}^{CS,max}=12, if

$$\frac{\frac{12}{{P}_{F}} {m}_{S RS , {B}_{SRS}}}{{K}_{TC}} = 6 ,$$

n_{SRS}^{CS}∈{0, 2, 4, 6, 8, 10} or n_{SRS}^{CS}∈{1, 3, 5, 7, 9, 11}; otherwise (e.g.

$$\frac{\frac{12}{{P}_{F}} {m}_{S RS , {B}_{SRS}}}{{K}_{TC}} >= 12 ) ,$$

n_{SRS}^{CS}∈{0, 1, . . . , 11}.

For a second example, for SRS resource configured with K_{TC}=4 where n_{SRS}^{CS,max}=12, if

$$\frac{\frac{12}{{P}_{F}} {m}_{S RS , {B}_{SRS}}}{{K}_{TC}} = 6 ,$$

n_{SRS}^{CS}∈{0, 2, 4, 6, 8, 10} or n_{SRS}^{CS}∈{1, 3, 5, 7, 9, 11}; otherwise (e.g.

$$\frac{\frac{12}{{P}_{F}} {m}_{SRS , {B}_{SRS}}}{{K}_{T C}} > = 12 ) ,$$

n_{SRS}^{CS}∈{0, 1, . . . , 11}.

For a third example, for SRS resource configured with K_{TC}=2 where n_{SRS}^{CS,max}=8, if

$$\frac{\frac{12}{{P}_{F}} {m}_{S RS , {B}_{SRS}}}{{K}_{TC}} = 6 ,$$

n_{SRS}^{CS}∈{0, 2, 4, 6} or n_{SRS}^{CS}∈{1, 3, 5, 7}, otherwise (e.g.

$$\frac{\frac{12}{{P}_{F}} {m}_{SRS , {B}_{S R S}}}{{K}_{T C}} > = 8 ) ,$$

n_{SRS}^{CS}∈{0, 1, . . . , 7}.

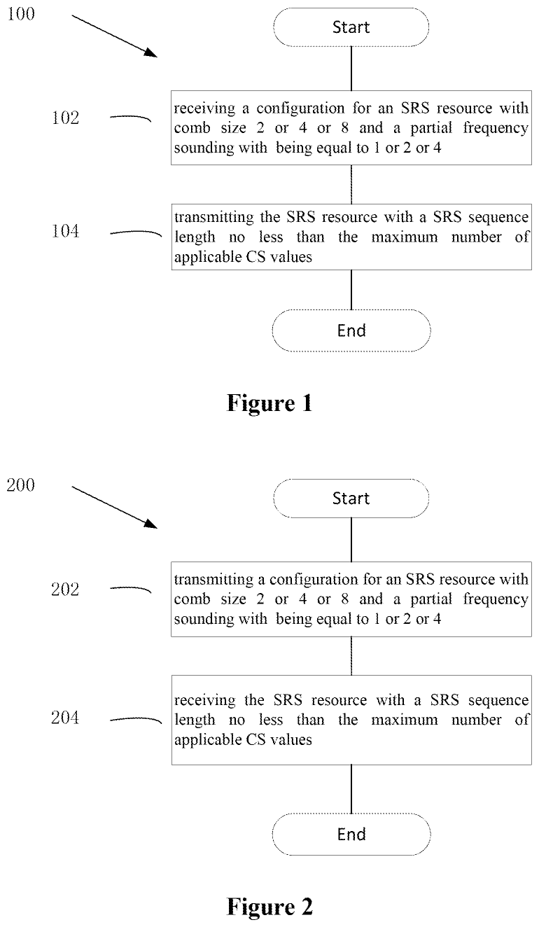

FIG. 1 is a schematic flow chart diagram illustrating an embodiment of a method 100 according to the present application. In some embodiments, the method 100 is performed by an apparatus, such as a remote unit. In certain embodiments, the method 100 may be performed by a processor executing program code, for example, a microcontroller, a microprocessor, a CPU, a GPU, an auxiliary processing unit, a FPGA, or the like.

The method 100 may comprise 102 receiving a configuration for an SRS resource with comb size (K_{TC}) 2 or 4 or 8 and a partial frequency sounding with P_{F} being equal to 1 or 2 or 4; and 104 transmitting the SRS resource with a SRS sequence length no less than the maximum number of applicable CS values.

In one embodiment, when K_{TC}=2, the P_{F} and SRS bandwidth (m_{SRS,b}_{_{SRS}}) are determined so that the SRS sequence length

$$\frac{\frac{12}{{P}_{F}} {m}_{SRS , {B}_{S R S}}}{{K}_{T C}}$$

is no less than 8, when K_{TC}=4, the P_{F} and the SRS bandwidth (m_{SRS,b}_{_{SRS}}) are determined so that the SRS sequence length

$$\frac{\frac{12}{{P}_{F}} {m}_{SRS , {B}_{S R S}}}{{K}_{T C}}$$

is no less than 12, and when K_{TC}=8, the P_{F} and the SRS bandwidth (M_{SRS,b}_{_{SRS}}) are determined so that the SRS sequence length

$$\frac{\frac{12}{{P}_{F}} {m}_{SRS , {B}_{S R S}}}{{K}_{T C}}$$

is no less than 12.

In another embodiment, when the SRS sequence length is 6, only partial cyclic shifts are the applicable CS values so that the SRS sequence length is no less than the number of applicable CS values. Preferably, the applicable CS values are 0, 2, 4 and 6, or 1, 3, 5 and 7 for K_{TC}=2, and the applicable CS values are 0, 2, 4, 6, 8 and 10, or 1, 3, 5, 7, 9 and 11 for K_{TC}=4 or 8.

FIG. 2 is a schematic flow chart diagram illustrating a further embodiment of a method 200 according to the present application. In some embodiments, the method 200 is performed by an apparatus, such as a base unit. In certain embodiments, the method 200 may be performed by a processor executing program code, for example, a microcontroller, a microprocessor, a CPU, a GPU, an auxiliary processing unit, a FPGA, or the like.

The method 200 may comprise 202 transmitting a configuration for an SRS resource with comb size (K_{TC}) 2 or 4 or 8 and a partial frequency sounding with P_{F} being equal to 1 or 2 or 4; and 204 receiving the SRS resource with a SRS sequence length no less than the maximum number of applicable CS values.

In one embodiment, when K_{TC}=2, the P_{F} and SRS bandwidth (m_{SRS,b}_{_{SRS}}) are determined so that the SRS sequence length

$$\frac{\frac{12}{{P}_{F}} {m}_{SRS , {B}_{S R S}}}{{K}_{T C}}$$

is no less than 8, when K_{TC}=4, the P_{F} and the SRS bandwidth (m_{SRS,b}_{_{SRS}}) are determined so that the SRS sequence length

$$\frac{\frac{12}{{P}_{F}} {m}_{SRS , {B}_{S R S}}}{{K}_{T C}}$$

is no less than 12, and when K_{TC}=8, the P_{F} and the SRS bandwidth (m_{SRS,b}_{_{SRS}}) are determined so that the SRS sequence length

$$\frac{\frac{12}{{P}_{F}} {m}_{SRS , {B}_{SRS}}}{{K}_{TC}}$$

is no less than 12.

In another embodiment, when the SRS sequence length is 6, only partial cyclic shifts are the applicable CS values so that the SRS sequence length is no less than the number of applicable CS values. Preferably, the applicable CS values are 0, 2, 4 and 6, or 1, 3, 5 and 7 for K_{TC}=2, and the applicable CS values are 0, 2, 4, 6, 8 and 10, or 1, 3, 5, 7, 9 and 11 for K_{TC}=4 or 8.

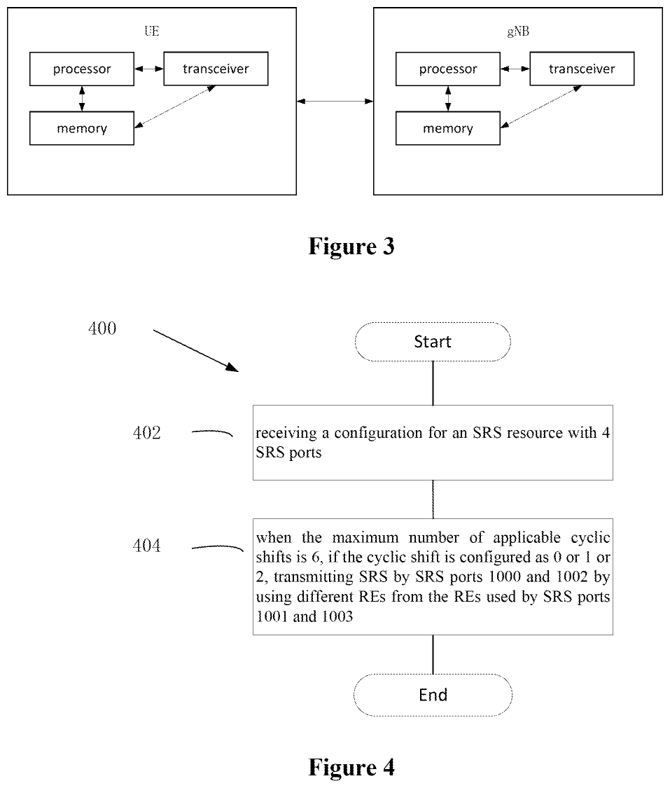

FIG. 3 is a schematic block diagram illustrating apparatuses according to one embodiment.

Referring to FIG. 3, the UE (i.e. the remote unit) includes a processor, a memory, and a transceiver. The processor implements a function, a process, and/or a method which are proposed in FIG. 1.

The UE comprises a receiver that receives a configuration for an SRS resource with comb size (K_{TC}) 2 or 4 or 8 and a partial frequency sounding with P_{F} being equal to 1 or 2 or 4; and a transmitter that transmits the SRS resource with a SRS sequence length no less than the maximum number of applicable CS values.

In one embodiment, when K_{TC}=2, the P_{F} and SRS bandwidth (m_{SRS,b}_{_{SRS}}) are determined so that the SRS sequence length

$$\frac{\frac{12}{{P}_{F}} {m}_{SRS , {B}_{SRS}}}{{K}_{TC}}$$

is no less than 8, when K_{TC}=4, the P_{F} and the SRS bandwidth (m_{SRS,b}_{_{SRS}}) are determined so that the SRS sequence length

$$\frac{\frac{12}{{P}_{F}} {m}_{SRS , {B}_{SRS}}}{{K}_{TC}}$$

is no less than 12, and when K_{TC}=8, the P_{F} and the SRS bandwidth (m_{SRS,B}_{_{SRS}}) are determined so that the SRS sequence length

$$\frac{\frac{12}{{P}_{F}} {m}_{SRS , {B}_{SRS}}}{{K}_{TC}}$$

is no less than 12.

In another embodiment, when the SRS sequence length is 6, only partial cyclic shifts are the applicable CS values so that the SRS sequence length is no less than the number of applicable CS values. Preferably, the applicable CS values are 0, 2, 4 and 6, or 1, 3, 5 and 7 for K_{TC}=2, and the applicable CS values are 0, 2, 4, 6, 8 and 10, or 1, 3, 5, 7, 9 and 11 for K_{TC}=4 or 8.

Referring to FIG. 3, the gNB (i.e. base unit) includes a processor, a memory, and a transceiver. The processor implements a function, a process, and/or a method which are proposed in FIG. 2.

The base unit comprises a transmitter that transmits a configuration for an SRS resource with comb size (K_{TC}) 2 or 4 or 8 and a partial frequency sounding with P_{F} being equal to 1 or 2 or 4; and a receiver that receives the SRS resource with a SRS sequence length no less than the maximum number of applicable CS values.

In one embodiment, when K_{TC}=2, the P_{F} and SRS bandwidth (m_{SRS,b}_{_{SRS}}) are determined so that the SRS sequence length

$$\frac{\frac{12}{{P}_{F}} {m}_{SRS , {B}_{SRS}}}{{K}_{TC}}$$

is no less than 8, when K_{TC}=4, the P_{F} and the SRS bandwidth (m_{SRS,b}_{_{SRS}}) are determined so that the SRS sequence length

$$\frac{\frac{12}{{P}_{F}} {m}_{SRS , {B}_{SRS}}}{{K}_{TC}}$$

is no less than 12, and when K_{TC}=8, the P_{F} and the SRS bandwidth (n_{SRS,b}_{_{SRS}}) are determined so that the SRS sequence length

$$\frac{\frac{12}{{P}_{F}} {m}_{SRS , {B}_{SRS}}}{{K}_{TC}}$$

is no less than 12.

In another embodiment, when the SRS sequence length is 6, only partial cyclic shifts are the applicable CS values so that the SRS sequence length is no less than the number of applicable CS values. Preferably, the applicable CS values are 0, 2, 4 and 6, or 1, 3, 5 and 7 for K_{TC}=2, and the applicable CS values are 0, 2, 4, 6, 8 and 10, or 1, 3, 5, 7, 9 and 11 for K_{TC}=4 or 8.

FIG. 4 is a schematic flow chart diagram illustrating an embodiment of a method 400 according to the present application. In some embodiments, the method 400 is performed by an apparatus, such as a remote unit. In certain embodiments, the method 400 may be performed by a processor executing program code, for example, a microcontroller, a microprocessor, a CPU, a GPU, an auxiliary processing unit, a FPGA, or the like.

The method 400 may comprise 402 receiving a configuration for an SRS resource with 4 SRS ports (Nₐₚ^{SRS}=4); and 404 when the maximum number of applicable cyclic shifts is 6, if the cyclic shift is configured as 0 or 1 or 2, transmitting SRS by SRS ports 1000 and 1002 by using different REs from the REs used by SRS ports 1001 and 1003.

In some embodiment, the cyclic shifts for different SRS ports in the SRS resource is obtained according to

$${n}_{SRS}^{CS , i} = ⌊ {n}_{SRS}^{CS} + \frac{{n}_{SRS}^{CS , max} ( {p}_{i} - 1000 )}{{N}_{ap}^{SRS}} ⌋ mod {n}_{SRS}^{CS , max} or$$

$${n}_{SRS}^{CS , i} = ⌊ ( {n}_{SRS}^{CS} + \frac{{n}_{SRS}^{CS , max} ( {p}_{i} - 1000 )}{{N}_{ap}^{SRS}} ) mod {n}_{SRS}^{CS , max} ⌋ ,$$

where n_{SRS}^{CS,max} is the maximum number of applicable cyclic shifts, n_{SRS}^{CS}∈{0, 1, . . . , n_{SRS}^{CS,max}−1}, i=0, 1, 2 and 3, pᵢ=1000, 1001, 1002 and 1003, and Nₐₚ^{SRS}=4.

In some other embodiment, the frequency-domain starting position for SRS ports 1000 and 1002 is determined by k̅_{TC}, and the frequency-domain starting position for SRS ports 1001 and 1003 is determined by (k̅_{TC}+K_{TC}/2) mod K_{TC}, where k̅_{TC} is the transmission comb offset for the SRS resource.

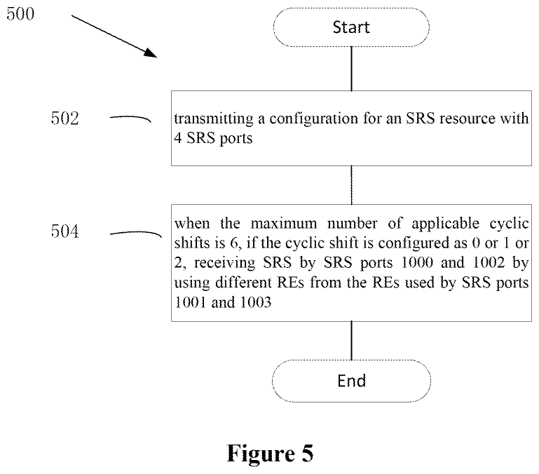

FIG. 5 is a schematic flow chart diagram illustrating a further embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 transmitting a configuration for an SRS resource with 4 SRS ports (Nₐₚ^{SRS}=4); and 504 when the maximum number of applicable cyclic shifts is 6, if the cyclic shift is configured as 0 or 1 or 2, receiving SRS by SRS ports 1000 and 1002 by using different REs from the REs used by SRS ports 1001 and 1003.

In some embodiment, the cyclic shifts for different SRS ports in the SRS resource is obtained according to

$${n}_{SRS}^{CS , i} = ⌊ {n}_{SRS}^{CS} + \frac{{n}_{SRS}^{CS , max} ( {p}_{i} - 1000 )}{{N}_{ap}^{SRS}} ⌋ mod {n}_{SRS}^{CS , max} or$$

$${n}_{SRS}^{CS , i} = ⌊ ( {n}_{SRS}^{CS} + \frac{{n}_{SRS}^{CS , max} ( {p}_{i} - 1000 )}{{N}_{ap}^{SRS}} ) mod {n}_{SRS}^{CS , max} ⌋ ,$$

where n_{SRS}^{max} is the maximum number of applicable cyclic shifts, n_{SRS}^{CS}∈{0, 1, . . . , n_{SRS}^{CS,max}−1}=0, 1, 2 and 3, pᵢ=1000, 1001, 1002 and 1003, and Nₐₚ^{SRS}=4.

In some other embodiment, the frequency-domain starting position for SRS ports 1000 and 1002 is determined by k̅_{TC}, and the frequency-domain starting position for SRS ports 1001 and 1003 is determined by (k̅_{TC}+K_{TC}/2) mod K_{TC}, where k̅_{TC} is the transmission comb offset for the SRS resource.

Referring to FIG. 3, the UE (i.e. the remote unit) includes a processor, a memory, and a transceiver. The processor may implement a function, a process, and/or a method which are proposed in FIG. 4.

The remote unit (e.g. UE) comprises a receiver that receives a configuration for an SRS resource with 4 SRS ports (Nₐₚ^{SRS}=4); and a transmitter that, when the maximum number of applicable cyclic shifts is 6, if the cyclic shift is configured as 0 or 1 or 2, transmits SRS by SRS ports 1000 and 1002 by using different REs from the REs used by SRS ports 1001 and 1003.

In some embodiment, the cyclic shifts for different SRS ports in the SRS resource is obtained according to

$${n}_{SRS}^{CS , i} = ⌊ {n}_{SRS}^{CS} + \frac{{n}_{SRS}^{CS , max} ( {p}_{i} - 1000 )}{{N}_{ap}^{SRS}} ⌋ mod {n}_{SRS}^{CS , max} or$$

$${n}_{SRS}^{CS , i} = ⌊ {n}_{SRS}^{CS} + \frac{{n}_{SRS}^{CS , max} ( {p}_{i} - 1000 )}{{N}_{ap}^{SRS}} ) mod {n}_{SRS}^{CS , max} ⌋ ,$$

where n_{SRS}^{CS,max} is the maximum number of applicable cyclic shifts, n_{SRS}^{CS}∈{0, 1, . . . , n_{SRS}^{CS,max}−1}, i=0, 1, 2 and 3, pᵢ=1000, 1001, 1002 and 1003, and Nₐₚ^{SRS}=4.

In some other embodiment, the frequency-domain starting position for SRS ports 1000 and 1002 is determined by k̅_{TC}, and the frequency-domain starting position for SRS ports 1001 and 1003 is determined by (k̅_{TC}+K_{TC}/2) mod K_{TC}, where k̅_{TC} is the transmission comb offset for the SRS resource.

Referring to FIG. 3, the gNB (i.e. base unit) includes a processor, a memory, and a transceiver. The processor may implement a function, a process, and/or a method which are proposed in FIG. 5.

The base unit comprises a transmitter that transmits a configuration for an SRS resource with 4 SRS ports (Nₐₚ^{SRS}=4); and a receiver that, when the maximum number of applicable cyclic shifts is 6, if the cyclic shift is configured as 0 or 1 or 2, receives SRS by SRS ports 1000 and 1002 by using different REs from the REs used by SRS ports 1001 and 1003.

In some embodiment, the cyclic shifts for different SRS ports in the SRS resource is obtained according to

$${n}_{SRS}^{CS , i} = ⌊ {n}_{SRS}^{CS} + \frac{{n}_{SRS}^{CS , max} ( {p}_{i} - 1000 )}{{N}_{ap}^{SRS}} ⌋ mod {n}_{SRS}^{CS , max} or$$

$${n}_{SRS}^{CS , i} = ⌊ ( {n}_{SRS}^{CS} + \frac{{n}_{SRS}^{CS , max} ( {p}_{i} - 1000 )}{{N}_{ap}^{SRS}} ) mod {n}_{SRS}^{CS , max} ⌋ ,$$

where n_{SRS}^{CS,max} is the maximum number of applicable cyclic shifts, n_{SRS}^{CS}∈{0, 1, . . . , n_{SRS}^{CS,max}−1}, i=0, 1, 2 and 3, pᵢ=1000, 1001, 1002 and 1003, and Nₐₚ^{SRS}=4.

In some other embodiment, the frequency-domain starting position for SRS ports 1000 and 1002 is determined by k̅_{TC}, and the frequency-domain starting position for SRS ports 1001 and 1003 is determined by (k̅_{TC}+K_{TC}/2) mod K_{TC}, where k_{TC} is the transmission comb offset for the SRS resource.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to
receive a configuration for sounding reference signal (SRS) resource with comb size (K_{TC}) 2 or 4 or 8 and a partial frequency sounding with P_{F} being equal to 1 or 2 or 4; and
transmit the SRS resource with a SRS sequence length no less than a maximum number of applicable cyclic shift (CS) values.

2. The UE of claim 1, wherein,
when K_{TC}=2, the P_{F} and SRS bandwidth (m_{SRS,b}_{_{SRS}}) are determined such that the SRS sequence length
$$\frac{\frac{12}{{P}_{F}} {m}_{SRS , {B}_{SRS}}}{{K}_{TC}}$$
is no less than 8,
when K_{TC}=4, the P_{F} and the SRS bandwidth (m_{SRS,b}_{_{SRS}}) are determined such that the SRS sequence length
$$\frac{\frac{12}{{P}_{F}} {m}_{SRS , {B}_{SRS}}}{{K}_{TC}}$$
is no less than 12, and
when K_{TC}=8, the P_{F} and the SRS bandwidth (m_{SRS,b}_{_{SRS}}) are determined such that the SRS sequence length
$$\frac{\frac{12}{{P}_{F}} {m}_{SRS , {B}_{SRS}}}{{K}_{TC}}$$
is no less than 12.

3. The UE of claim 1, wherein,
when the SRS sequence length is 6, only partial cyclic shifts are the applicable CS values such that the SRS sequence length is no less than a number of applicable CS values.

4. The UE of claim 3, wherein,
the applicable CS values are 0, 2, 4 and 6, or 1, 3, 5 and 7 for K_{TC}=2, and the applicable CS values are 0, 2, 4, 6, 8 and 10, or 1, 3, 5, 7, 9 and 11 for K_{TC}=4 or 8.

5. (canceled)

6. (canceled)

7. A base unit, comprising:
at least one memory; and
at least one processor coupled with the at least one memory and configured to cause the base unit to
transmit a configuration for a sounding reference signal (SRS) resource with comb size (K_{TC}) 2 or 4 or 8 and a partial frequency sounding with P_{F} being equal to 1 or 2 or 4; and
receive the SRS resource with a SRS sequence length no less than a maximum number of applicable cyclic shift (CS) values.

8. A user equipment (UE), comprising:
at least one memory; and
at least one processor coupled with the at least one memory and configured to cause the UE to:
receive a configuration for sounding reference signal (SRS) resource with 4 SRS ports (Nₐₚ^{SRS}=₄); and
when a maximum number of applicable cyclic shifts (CSs) is 6, and if the cyclic shift is configured as 0 or 1 or 2, a frequency-domain starting position for SRS ports 1000 and 1002 is determined by k̅_{TC}, which is a transmission comb offset for the SRS resource.

9. The UE of claim 8, wherein, the cyclic shifts for different SRS ports in the SRS resource is obtained according to
$${n}_{SRS}^{CS , i} = ⌊ {n}_{SRS}^{CS} + \frac{{n}_{SRS}^{CS , max} ( {p}_{i} - 1000 )}{{N}_{ap}^{SRS}} ⌋ mod {n}_{SRS}^{CS , max} or$$
$${n}_{SRS}^{CS , i} = ⌊ ( {n}_{SRS}^{CS} + \frac{{n}_{SRS}^{CS , max} ( {p}_{i} - 1000 )}{{N}_{ap}^{SRS}} ) mod {n}_{SRS}^{CS , max} ⌋ ,$$
where n_{SRS}^{CS,max} is a maximum number of applicable cyclic shifts, n_{SRS}^{CS}∈{0, 1, . . . , n_{SRS}^{CS,max}−1}, i=0, 1, 2 and 3, pᵢ=1000, 1001, 1002 and 1003, and Nₐₚ^{SRS}=4.

10. The UE of claim 8, wherein, the frequency-domain starting position for SRS ports 1001 and 1003 is determined by (k̅_{TC}+K_{TC}/2) mod K_{TC}.

11. (canceled)

12. (canceled)

13. A base unit, comprising:
at least one memory, and
at least one processor coupled with the at least one memory and configured to cause the base unit to:
transmit a configuration for an SRS resource with 4 SRS ports (Nₐₚ^{SRS}=4); and
determine, when a maximum number of applicable cyclic shifts is 6, if a cyclic shift is configured as 0 or 1 or 2, a frequency-domain starting position for SRS ports 1000 and 1002 by k̅_{TC}, which is a transmission comb offset for the SRS resource.
